(19) United States
(12) Patent Application Publication
(10) Pub. No.: US 2003/0193835 A1
(43) Pub. Date: Oct. 16, 2003

(54) Electric pot Stirrer

(76) Inventor: James E. Richardson, Eliot, ME (US)

Correspondence Address: Thomas A. Gallagher, Esq., 65 Woods End Road, Stamford, CT, 06905, US

(21) Appl. No.: 10/339,270

(22) Filed: Jan. 9, 2003

Related U.S. Application Data
(60) Provisional application No. 60/371,520, filed on Apr. 10, 2002.

(51) Int. Cl. B01F 7/20

(52) U.S. Cl. 366/282; 366/284; 366/286; 366/311

(57) ABSTRACT

An automatic pot stirring device according to the invention includes a state of the art rechargeable battery, adjustable support arms, and a stirring paddle. An important aspect of the invention is that it can be used with various sizes of saucepans already in a cook's kitchen by adjusting the support arms and the stirring paddle. The device can be used and stored easily, and maintains an attractive design. There is no need for an electrical outlet nearby. Moreover, the device uses efficient engineering and parts to minimize manufacturing costs. The stirring paddle has a fluid dynamic design which assures efficient stirring.

This application claims the benefit of provisional application serial No. 60/371,520, filed Apr. 10, 2002, the complete disclosure of which is hereby incorporated by reference herein.

### BACKGROUND OF THE INVENTION

1. Field of the Invention

The invention relates to kitchen appliances. More particularly, the invention relates to cordless electrical kitchen appliances.

2. Brief Description of the Prior Art

Though mixing food ingredients in a heated pan has been, throughout history, a basic requirement in numerous cooking recipes, there is currently no product that allows either stirring or mixing to take place in a stove-top heated pan. At the present time, mechanized stirring and mixing must take place in a separate bowl, nullifying the expansive quality that heat brings to many sauces, custards, gravies, gelatins, cereals and more. As a result, the only way to properly stir or mix in a heated pan is by hand. Stirring and mixing by hand can be time consuming, tiring and even dangerous.

Several attempts have been made during the past three decades to develop a successful automated pan stirrer. However, each design was built upon a significantly flawed premise. For example, T-FAL currently markets an electric saucepan in Europe that contains a built in stirring device. Unfortunately, this device requires that the user purchase an expensive, undersized pan having no other useful purpose. In addition, due to the large currents required by the device for heating the saucepan, its use is limited to locations having an electrical outlet into which it can be plugged. For these and other reasons, the device has failed to gain commercial acceptance in the United States.

Since the 1960's, patents have been filed all over the world for stirring devices that can be attached to an existing saucepan. In each instance, the device has been cumbersome and far too expensive to manufacture for commercial acceptance.

### SUMMARY OF THE INVENTION

It is therefore an object of the invention to provide an automatic pot stirring device.

It is also an object of the invention to provide an automatic pot stirring device which can be used with a variety of pots.

It is another object of the invention to provide an automatic pot stirring device which is electrically operated.

It is yet another object of the invention to provide an automatic pot stirring device which does not need to be plugged into an electrical outlet.

It is another object of the invention to provide an automatic pot stirring device which is inexpensive to produce.

It is still another object of the invention to provide an automatic pot stirring device which is easy to use and to clean.

In accord with these objects which will be discussed in detail below, the automatic pot stirring device according to the invention includes a battery power supply, adjustable support arms, and a stirring paddle. An important aspect of the invention is that it can be used with various sizes of saucepans already in a cook's kitchen by adjusting the support arms and the stirring paddle. The device can be used and stored easily, and maintains an attractive design. Moreover, the device uses efficient engineering and parts to minimize manufacturing costs. The stirring paddle has a fluid dynamic design which assures efficient stirring.

### BRIEF DESCRIPTION OF THE DRAWINGS

FIG. 1 is an exploded perspective view illustrating the major component parts of the invention;

FIG. 2 is an assembled perspective view illustrating the invention with two adjustable arms deployed and one side of the adjustable paddle extended;

FIG. 3 is a side elevational view illustrating the profile of the adjustable paddle;

FIG. 4 is a top plan view illustration the invention with all three arms deployed and resting on the lip of a saucepan;

FIG. 5 is a broken sectional view of one arm of the invention in a retracted state for use with smaller saucepans;

FIG. 6 is a view similar to FIG. 5 illustrating the arm extended for use with larger saucepans;

FIG. 7 is an exploded perspective view of an adjustable supporting arm;

FIG. 8 is a perspective view of an embodiment of the invention with the paddle removed;

FIG. 9 is a perspective view of an embodiment of the invention with the presently preferred paddle;

FIG. 10 is a perspective view of the presently preferred paddle;

FIG. 11 is a top plan view of the pot stirrer with the presently preferred paddle

FIG. 12 is a schematic diagram of a circuit for use in a second embodiment of the invention which permits intermittent stirring;

FIG. 13 is a perspective view of a third embodiment of the invention providing times and intermittent stirring with rechargeable batteries; and

FIG. 14 is a view similar to FIG. 13 of a third embodiment utilizing a touch sensitive or membrane covered control.

### DETAILED DESCRIPTION OF THE PREFERRED EMBODIMENTS

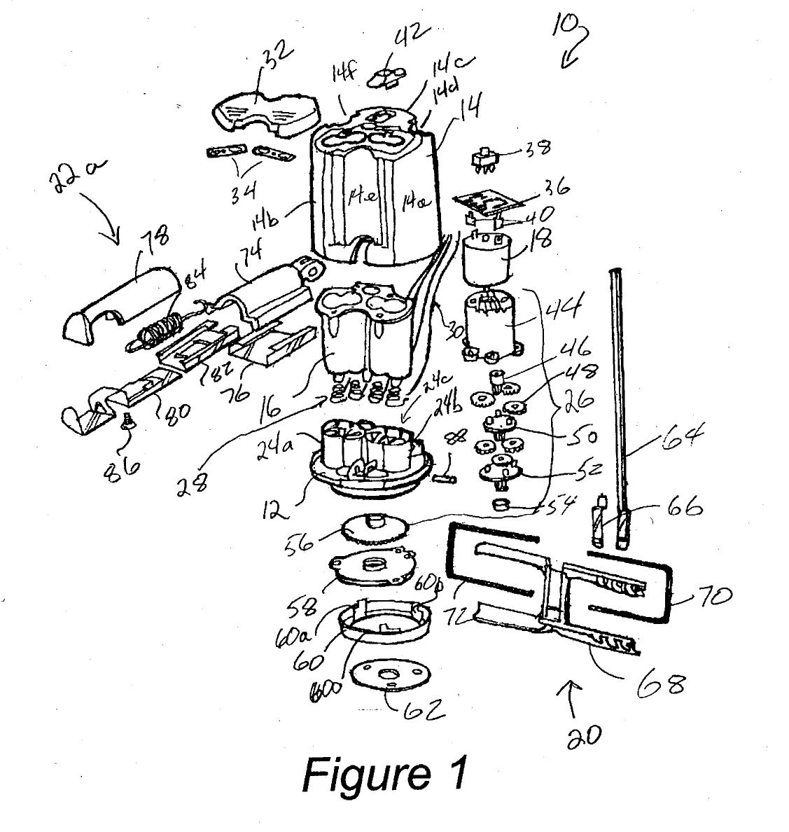

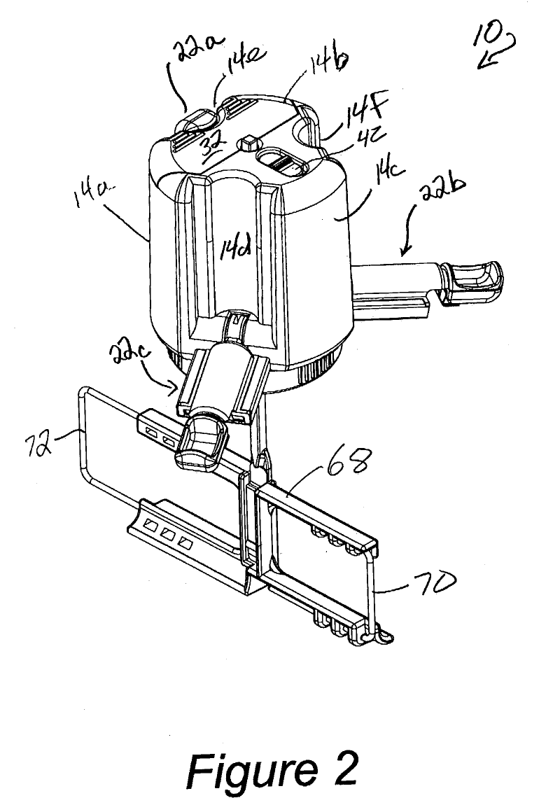

Turning now to FIGS. 1 and 2, the major components of the stirring device 10 include: a chassis 12, a cover 14, a battery holder 16, an electric motor 18, a paddle assembly 20, and three mounting arm assemblies 22a-22c. As seen in the Figures, the chassis 12 is generally divided into three portions, two of which are occupied by footings 24a, 24b for receiving the battery holder 16 and the third of which 24c receives the motor 18 and a drive train 26. The cover 14 is similarly divided into three parts 14a-14c which correspond to the three parts 24a-24c of the chassis 12.

The battery holder 16 is provided with the usual spring contacts 28 and connecting wires 30. The top of the cover 14 (in portions 14a, 14b) is provided with a removable non-conductive battery cover 32 with interior conductive battery contacts 34. The wires 30 from the battery holder 16 are electrically coupled to a circuit board 36 which carries a slide switch 38 and which is coupled by brass motor contact extension clips 40 to the motor 18. The slide switch 38 is covered by the portion 14c of the cover 14 and is provided with a decorative thumb slide 42.

The motor 18 is preferably a Johnson Electric, part number 02J2035/001 which was designed for electric screwdrivers. As mentioned above, the motor 18 is coupled to the paddle assembly 20 by a gear train 26. The gear train 26 includes a glass fiber reinforced nylon ring gear 44, a glass fiber reinforced nylon motor hub gear 46, six glass fiber reinforced nylon satellite gears 48, a zinc die cast top gear arm 50, a zinc die cast bottom gear arm 52, an oil filled bronze bushing 54, and a glass fiber reinforced nylon drive gear 56. The gear assembly is covered by a plastic gear cover 58, a plastic locking base 60, and a plastic locking base flange 62.

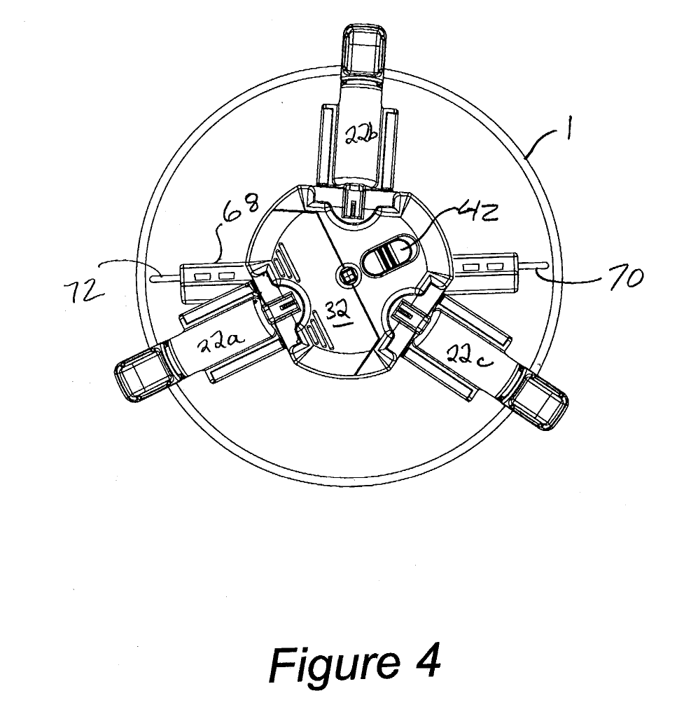

The paddle assembly 20 includes a stainless steel paddle shaft 64 with a stainless steel clip 66 at its lower end, a generally H-shaped plastic paddle 68, and two generally U-shaped stainless steel TEFLON coated paddle extensions 70, 72. The paddle 68 is removably coupled to the paddle shaft 64 by the clip 66. The paddle extensions 70-72 are adjustably deceived by the ends of the paddle 68 as seen best in FIGS. 2 and 4.

The cover 14 also defines three longitudinal wells 14d-14f within which each of the three adjustable arms 22a-22c are hingedly received. Each arm assembly, e.g. 22a shown in FIG. 1, includes a plastic upper outer arm part 74, a stainless steel lower outer arm part 76, a plastic upper inner arm part 78, a stainless steel arm clip 80, a stainless steel arm guide 82, a stainless steel spring 84, an assembly screw 86 and a stainless steel pivot pin 88. The upper outer arm part 74 is hingedly coupled to the bottom of the well 14e by the pin 88 which also holds one end of the spring 84. The lower outer arm part 76 slides over the part 74 engaging it with flanges. The arm clip 80 and the arm guide 82 are slidably disposed between the parts 74 and 76. The other end of the spring 84 is coupled to the clip 80 which is fastened to the upper inner part 78 with the screw 86.

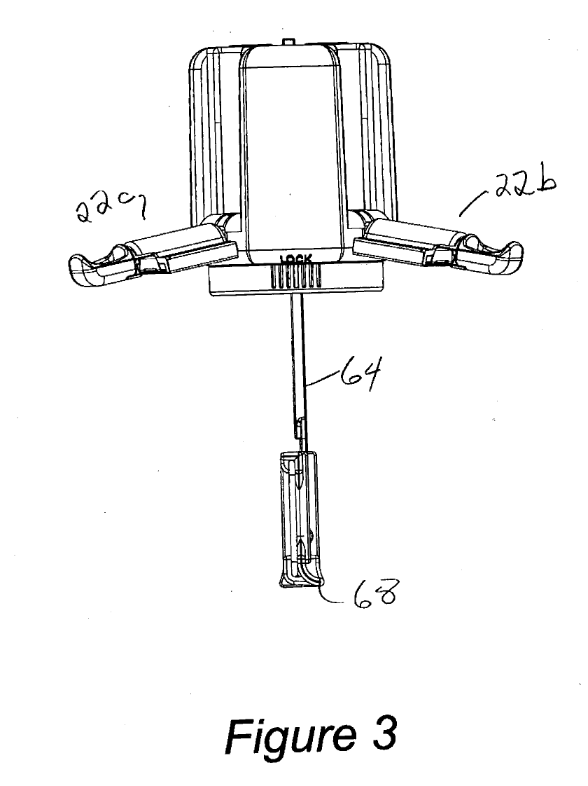

Referring now to FIGS. 2 and 4, it can be seen that the paddle extensions 70, 72 are movable into and out of the paddle 68. This allows the paddle assembly to be adjusted to pots of different diameter. As seen best in FIGS. 2, 3, and 4 the paddle shaft 64 is rectangular in cross section and slides freely through the center of the apparatus thereby adjusting to pots of different depth.

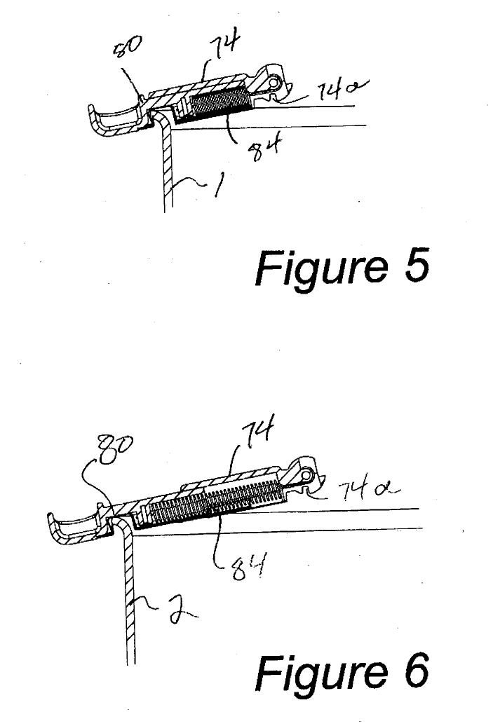

FIGS. 2-5 show the arms 22a-22c retracted to their shortest length for suspending the invention over a pot of relatively small diameter. This is illustrated most clearly in FIG. 5 which shows the spring 84 unextended in reference to pot 1. FIG. 6, however, illustrates the arm extended to accommodate a larger diameter pot 2. Here the arm clip 80 engaged the lip of the pot 2 with the spring 84 extended. FIGS. 5 and 6 also illustrate a detent 74a in the outer arm assembly 74. This detent is selectively engaged by rotating the locking base 60 which maintains the arms 22a-22c in a lowered position during operation and allows the arms to be raised for storage.

The overall dimensions of the apparatus are approximately 3-4″ tall and 3-4″ in overall diameter with the arms folded up. Thus, with the arms deployed but not extended, the apparatus will comfortably fit on a pot approximately 6″ in diameter. With the arms extended, the apparatus will comfortably fit on a pot having a diameter of approximately 9″ in diameter. The paddle shaft is approximately 8″.

From the foregoing it will be appreciated that operation of the apparatus is very simple. The paddle assembly is installed and the locking base is rotated to allow the three arms to drop and is then rotated to lock them in the down position. The paddle extensions are adjusted to the diameter of the pot. The arms are extended so that the arm clips engaged the lip of the pot. With the apparatus thus in place, the slide switch is moved to start the rotation of the paddle assembly. When done, the switch is moved to stop the paddle assembly from rotation. The apparatus is easily removed from the pot and the paddle assembly is easily removed from the apparatus for cleaning. The locking base is rotated, the arms lifted and locked in place for compact storage.

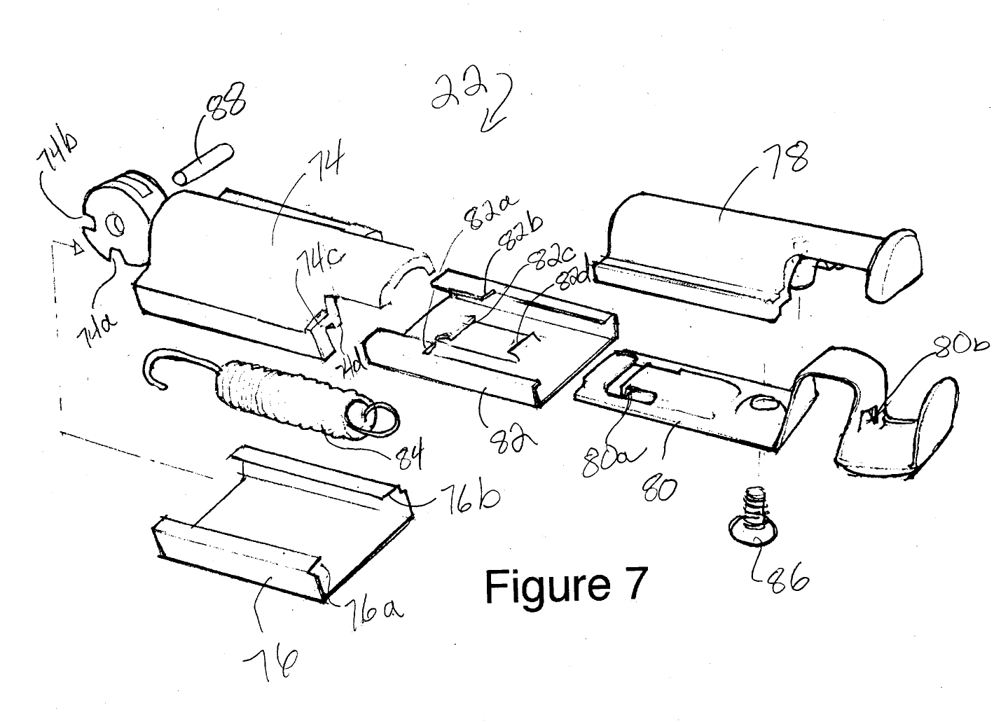

Turning now to FIG. 7, the presently preferred supporting arm assembly 22 is illustrated in greater detail. As described above, each arm 22 includes a plastic upper outer arm part 74, a stainless steel lower outer arm part 76, a plastic upper inner arm part 78, a stainless steel arm clip 80, a stainless steel arm guide 82, a stainless steel spring 84, an assembly screw 86 and a stainless steel pivot pin 88. The upper outer arm part 74 is hingedly coupled to the bottom of the well 14e (FIG. 1) by the pin 88 which also holds one end of the spring 84. The lower outer arm part 76 slides over the part 74 engaging it with flanges. The arm clip 80 and the arm guide 82 are slidably disposed between the parts 74 and 76. The other end of the spring 84 is coupled to the clip 80 which is fastened to the upper inner part 78 with the screw 86.

According to the presently preferred embodiment, the inner part 78 and attached arm clip 80 are designed to extend approximately 1″ from the outer arm parts 74, 76. The arm guide 82 bridges the connection between the inner and outer arm parts. There are two stops 74c (the other not seen) on the upper outer arm part 74 which limits the travel of the arm guide 82 by contacting the shoulders 82a, 82b. The clip 80 has a depending stop 80a which limits its movement between stops 82c, 82d. A barb 80b is provided to engage the rim of a pot. Stops 74d (the other not seen) engage the shoulders 76a, 76b of the lower outer arm part.

As mentioned above, the hinged coupling of the upper arm part 74 is provided with two locking slots 74a, 74b which selectively engage the locking base 60 (FIG. 1) which is provided with three raised fins 60a-60c. These fins, when aligned with the locking slots in the hinges of the arms 22 loct the arms in either the raised or lowered positions.

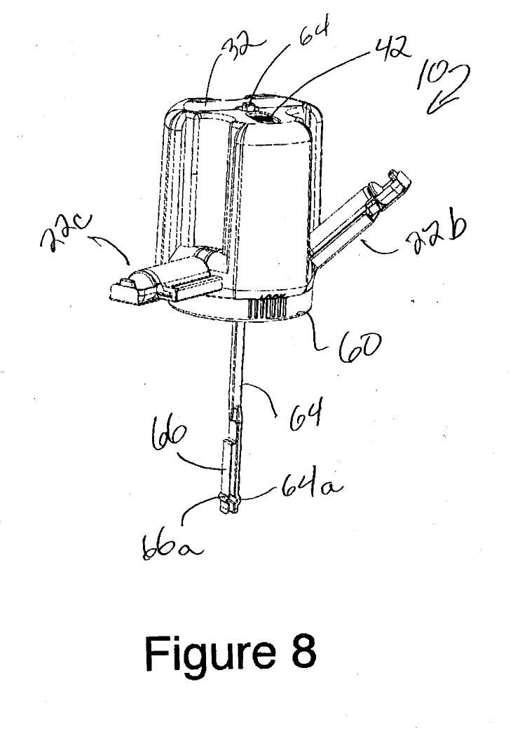

FIG. 8 illustrates the invention with the paddle removed from the paddle shaft 64. Here it can be seen that the lower end of the paddle shaft 64 and the attached clip 66 form a generally U-shaped (inverted) member which engages the paddle (not shown). These members each include detents 64a, 66a which engaged ridges on the paddle.

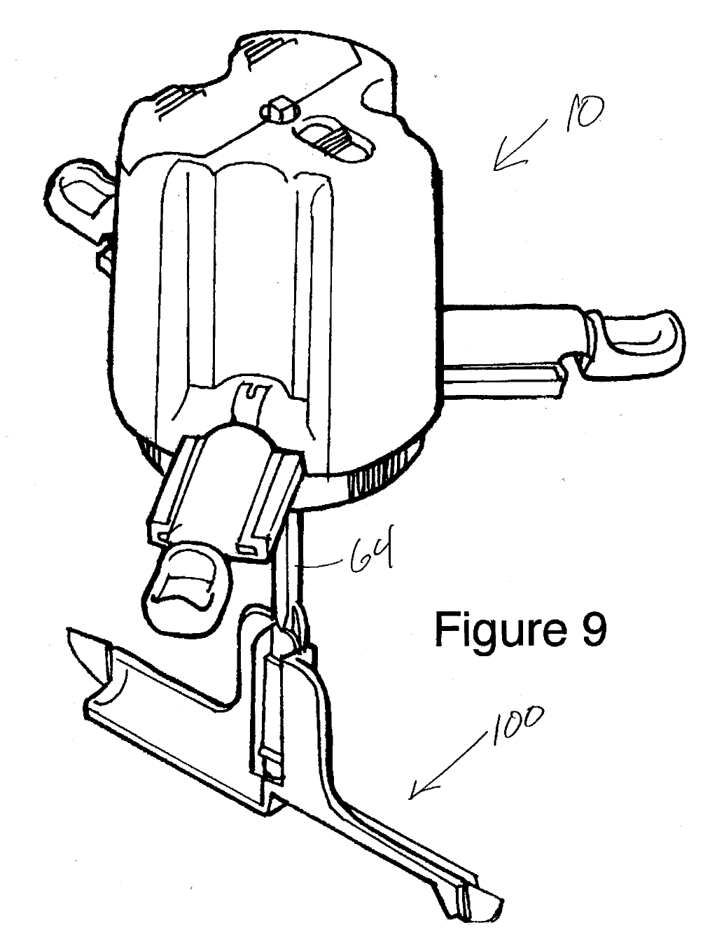

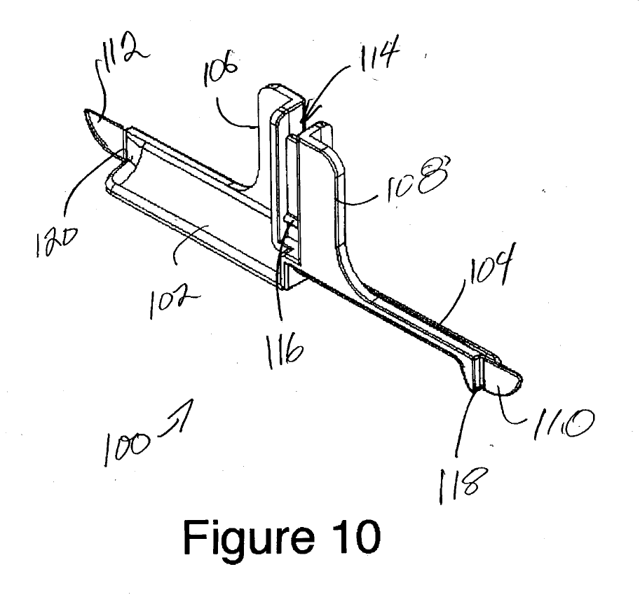

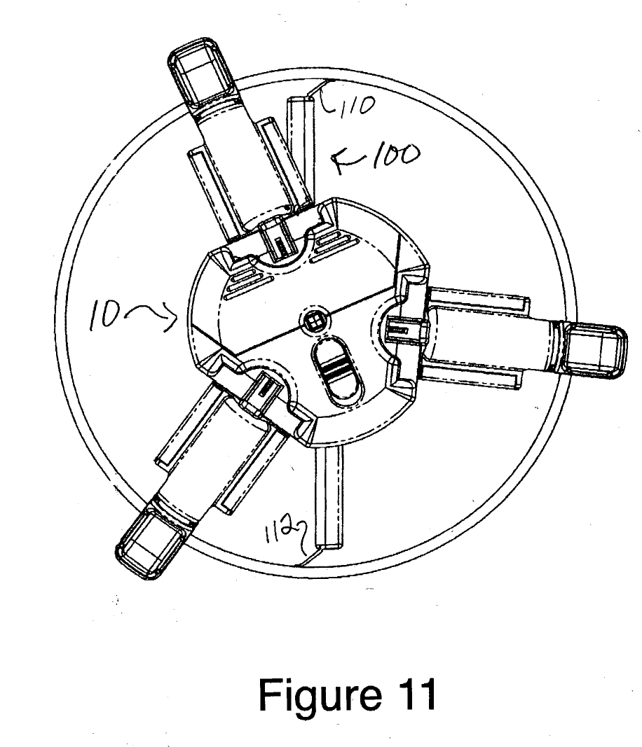

FIG. 9 illustrates the pot stirrer 10 with a presently preferred embodiment of a paddle 100 and FIG. 10 illustrates the paddle 100 in further detail. Turning to FIG. 10, the paddle 100 includes first and second plow sections 102, 108 each having an inner upstanding mover 106, 108 and an outer hinged wiper 110, 112. The upstanding movers 106, 108 define a central valley 114 having oppositely disposed ridges 116 (the other not seen) which engage the detents 64a, 66a of the paddle shaft and clip (FIG. 8). According to the presently preferred embodiment the paddle 100 is made of molded plastic (e.g. polypropylene) and the wipers 110, 112 are provided with living hinges 118, 120. As shown in FIGS. 9 and 10, the wipers 110, 112 have a lower radiused edge. This is designed to wipe the internal corner of a pot as shown in FIG. 11. The plow sections 102, 104 are designed to raise the contents of a pot upward and force the paddle downward to the bottom of the pot for a clean wiping action. The movers 106, 108 are designed to spin the raised contents of the pot in a circle. It will be appreciated that the paddles are diagonally symmetrical and may be made for either clockwise or counter-clockwise stirring. The paddles shown in the figures are designed for counter-clockwise stirring.

According to the presently preferred embodiment, the overall length of the paddle shaft is approximately 8.25″. The preferred paddles 100 arte provided in three sizes to fit most popular pot diameters. In each case, the height of the plow sections is approximately 0.75″. The wiper to wiper dimension varies among three paddles, i.e. about 6″, 7″, and 8.25″. The overall height at the center of the paddle also varies among the three sizes, i.e. about 2.3″, 2.2″ and 2.75″.

As mentioned above, the present invention contemplates three different models: an entry level model which uses four AA batteries and has a simple on-off switch. An intermediate level model includes rechargeable batteries and/or an intermittent operation mode. A high level model includes a timer, a digital display, and an alarm.

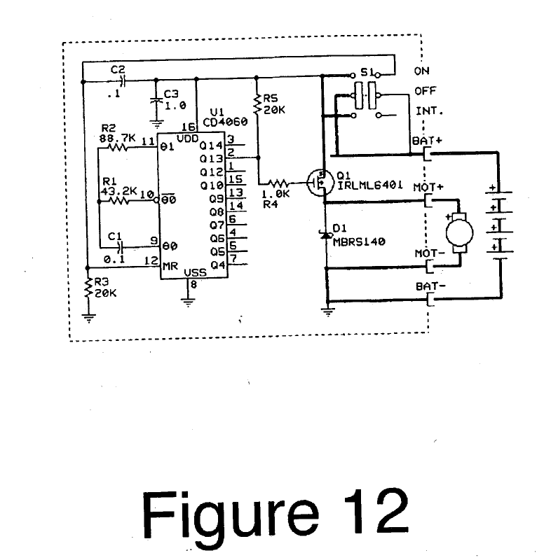

FIG. 12 is an exemplary circuit diagram offering on-off-intermittent operation. Table 1, below, identifies the electrical parts used in the circuit of FIG. 12.

TABLE 1

| Reference | Part Number | Description | Manufacturer |
|---|---|---|---|
| C1, C2 | 0805B104K160BT | 0.10 μF/16 V, | BC Components |
| | | 10%, X7R0805 | |
| | | (Digi-Key | |
| | | #BC1300CT) | |
| C3 | ECJ-2FB1C105K | 1.0 μF/16 V, 10%, | Panasonic |
| | | X5R, 0805 | |
| | | (Digi-Key | |
| | | #PCC2249CT | |
| D1 | MBRS140 | 1A/40 Vschottky | International |
| | | Rectifier, SMB | Rectifier |
| | | (Digi-Key | |
| | | #MBRS140CT) | |
| Q1 | IRLML6401 | P-channel | International |
| | | HEXFET, | Rectifier |
| | | 12 V/.050 Ohm, | |
| | | SOT23 (Digi-Key | |
| | | #IRLML6401CT) | |
| | 292-43.2 K | 43.2 K, 1/10 W, | Mouser |
| | | 1% 0805 | |
| R2 | 292-88.7 K | 88.7 K, 1/10 W, | Mouser |
| | | 1% 0805 | |
| R3, R5 | 292-20.0 K | 20.0 K, 1/10 W, | Mouser |
| | | 1% 0805 | |
| R4 | 292-1.00 K | 1.00 K, 1/10 W, | Mouser |
| | | 1% 0805 | |
| U1 | CD4060BC | CMOS 14-Stage | Various |
| | | Ripple Counter, | |
| | | SOIC16 | |
| S1 | Na | DPDT SMT | Various |
| | | Switch, Center | |
| | | Off | |

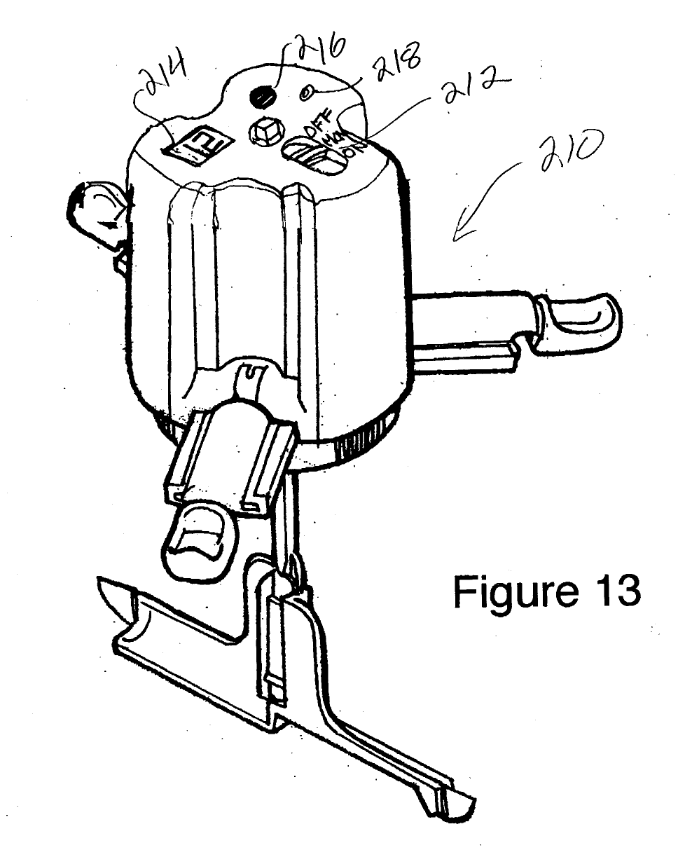

FIG. 13 illustrates another embodiment of a stirrer 210 according to the invention. This embodiment uses a three position switch 212 for selecting continuous or intermittent operation. It is also provided with a timer display 214, a time programming button 216 and a jack 218 for attaching a battery charger. The timer display 214 is two digit seven segment display, either LCD or LED. The display is coupled to a timer circuit (not shown) which is coupled to the motor (not shown) and the programming button 216. When the circuit is activated by switch 212, the display flashes, prompting the user to input a time value by pressing the button 216. The circuit is arranged so that pressing the button 216 increments the timer to a number of minutes which appears on the display 214. For example, pressing the button once increments the display by 1 minute. Further pressing increments the time in one minute intervals up to five minutes, after which time is incremented by 5 minutes each press. Thus, the timer can be set for as high as 55 minutes or as little as 1 minute. The timer is preferably coupled to an audio transducer (not shown) so that a sound is heard when the timer expires.

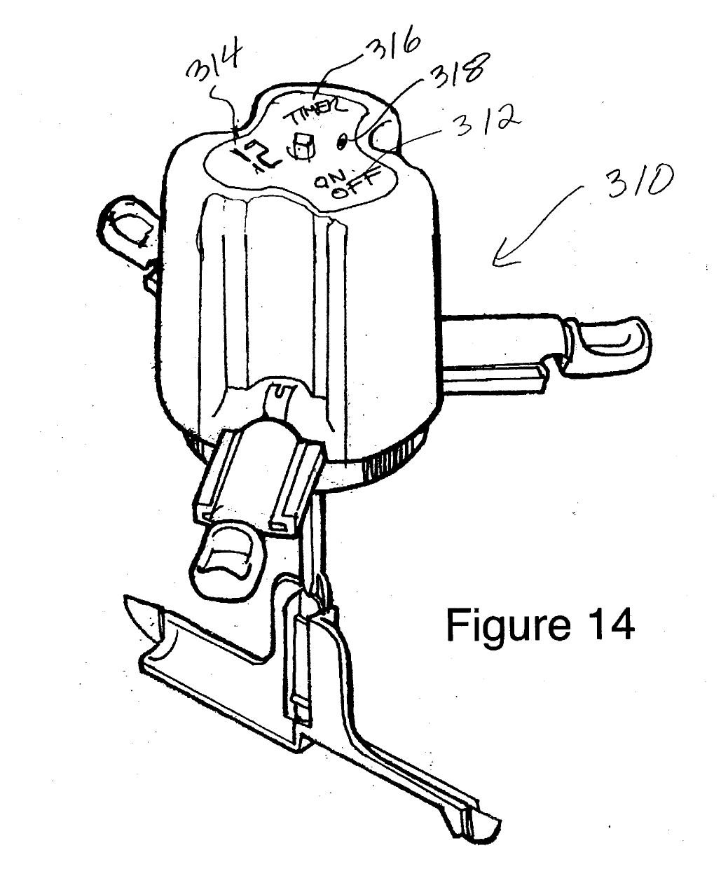

FIG. 14 shows yet another embodiment of a stirrer 310 which also includes an on-off switch 312, a display 314, a time programming button 316 and a jack 318 for connecting a battery charger. In this embodiment, the switch, display and button are located beneath a touch membrane. In this embodiment as well as the embodiment of FIG. 13, the timer circuit and display are preferably arranged so that the display counts down as the timer is running. Although the presently preferred circuit stops the motor when the timer expires, it could be arranged that expiration of the timer merely sounds the alarm without stopping the motor.

There has been described and illustrated herein an automatic pot stirring apparatus. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as so claimed.

What is claimed is:

1. An electric pot stirrer, comprising:
a) three retractable support arms, at least one being adjustable to accommodate pots of different diameter; and
b) a removable paddle assembly.

2. An electric pot stirrer according to claim 1, wherein:
each of said three arms is adjustable.

3. An electric pot stirrer according to claim 2, wherein:
each of said three arms is spring biased.

4. An electric pot stirrer according to claim 3, wherein:
said paddle assembly is adjustable to accommodate pots of different diameter.

5. An electric pot stirrer according to claim 1, wherein:
said paddle assembly includes a paddle and a detachable paddle shaft.

6. An electric pot stirrer according to claim 1, further comprising:
c) a battery operated motor coupled to said paddle assembly by a gear train.

7. An electric pot stirrer according to claim 5, wherein:
said paddle includes a pair of plow surfaces and a pair of hinged wipers, one coupled to each plow surface.

8. An electric pot stirrer according to claim 7, wherein:
said paddle shaft is vertically positionable relative to said arms.

9. An electric pot stirrer, comprising:
a) a motor assembly having means for suspending it on the lip of a pot; and
b) an adjustable paddle assembly including a paddle and a removable paddle shaft, wherein
said paddle includes a pair of plow surfaces and a pair of hinged wipers, one coupled to each plow surface.

10. An electric pot stirrer according to claim 9, wherein:
said paddle is plastic and said hinged wipers are coupled to said plow surfaces by living hinges.

11. An electric pot stirrer according to claim 10, wherein:
said paddle includes a central coupling structure for attaching it to said paddle shaft, and at least one stirring surface extending outward from said coupling structure.

12. An electric pot stirrer according to claim 9, wherein:
said paddle shaft is keyed and vertically adjustable relative to said motor assembly.

13. An electric pot stirrer, comprising:
a) a motor assembly; and
b a removable paddle assembly, wherein
said motor assembly includes a plurality of deployable supports for supporting the motor assembly on a pot, said supports being retractable into a compact configuration in which said supports are substantially vertically aligned in substantial parallel relationship to each other and being deployable to a position substantially 90° from the retracted position in which no two arms are parallel.

14. An electric pot stirrer according to claim 13, wherein:
said supports are hingedly coupled to said motor assembly and rotatable through approximately 90° from a retracted position to a deployed position.

15. An electric pot stirrer, comprising:
a substantially cylindrical housing having a vertical axis; and
a plurality of support arms hingedly coupled to the housing and rotatable from a position substantially parallel to the vertical axis to a position substantially orthogonal to the vertical axis.

16. An electric pot stirrer, according to claim 15, wherein:
each of said arms has a hinge member defining two spaced apart locking slots,
said housing includes a rotatable member having a plurality of spaced apart locking fins numbering the same number as the arms,
said arms and said rotatable member being arranged so that rotation of the rotatable member selectively aligns the fins with the hinge members to prevent the arms from being rotated.

17. An electric pot stirrer according to claim 16, wherein:
said rotatable member is rotatable to release the arms and allow them to rotate on their respective hinge members.

18. An electric pot stirrer, comprising:
a housing;
a plurality of arms each coupled at one end to the housing, each arm having an inner member and an outer member which are telescopingly arranged and coupled to each other with a spring which biases the inner arm into the outer arm.

19. An electric pot stirrer according to claim 18, wherein:
each arm having a free end which is provided with means for engaging the lip of a pot.

20. An electric pot stirrer according to claim 18, wherein:
each arm is provided with stop means for limiting the amount of movement of the inner member relative to the outer member.
